(19) United States
(12) Patent Application Publication
(10) Pub. No.: US 2025/0053294 A1
(43) Pub. Date: Feb. 13, 2025

(54) SYSTEMS AND METHODS FOR PROVIDING DELIBERATION PLATFORMS

(71) Applicant: University of Houston System, Houston, TX (US)

(72) Inventor: Ryan P. Kennedy, Houston, TX (US)

(21) Appl. No.: 18/798,254

(22) Filed: Aug. 8, 2024

Related U.S. Application Data
(60) Provisional application No. 63/518,168, filed on Aug. 8, 2023.

(51) Int. Cl. G06F 3/0486; G06F 3/0482

(52) U.S. Cl. CPC G06F 3/0486; G06F 3/0482

(57) ABSTRACT

In an embodiment, a deliberation experience system includes processor-executable instructions to: generate a deliberation platform including a plurality of forums and a manager dashboard to facilitate monitoring deliberation in each forum of the plurality of forums, the manager dashboard presented on a manager user device; receive a first input from the manager user device indicative of assigning a respective set of participant user devices to each forum and communicatively couple the respective set of participant user devices to each forum; receive a second input from the manager user device indicative of a selected issue guide of a plurality of issue guides, the selected issue guide including a plurality of discussion topics; and instruct a computer-automated moderator to initiate a guided discussion on each forum by progressing through each discussion topic of the selected issue guide in each forum and moderating discussion between participants on each forum.

### CROSS-REFERENCE TO RELATED APPLICATIONS

This application claims the benefit of and priority to U.S. Provisional Application No. 63/518,168, filed on Aug. 8, 2023, which is incorporated by reference herein in its entirety.

### TECHNICAL FIELD

The disclosure relates to deliberation experience systems and methods for managing deliberation experiences, such as by providing a deliberation platform.

### BACKGROUND

Generally, certain groups of people may deliberate on a topic to produce ideas and pathways for achieving various goals. These deliberations may encompass features of any suitable subjects or group interests, including education, politics, and/or business. In some cases, maintaining positive and constructive deliberation between individuals of a group typically involves heavy involvement of experienced human moderators that have been trained to guide the discussion. For example, a moderator for the group may guide the deliberation in an effort to allow multiple actions or opinions to be expressed within a reasonable time frame, while maintaining constructive conversation on each action or opinion.

As one application, civics or political science classes may endeavor to teach individuals how to engage in civil discourse via deliberations. Certain research indicates that civics classes that involve hands-on activities and discussion of current events can provide long-term, positive benefits for civic participation. However, most classes are large, impersonal, non-interactive, and may be unintentionally exclusionary, thus limiting an ability of individuals to engage in meaningful, constructive dialogs or deliberations. Accordingly, there is a need for systems and methods for enhanced deliberation experiences that can be scaled with less direct human guidance.

### SUMMARY

The present disclosure provides systems, devices, and methods for managing deliberation experiences via deliberation platforms. Embodiments include systems, devices, and methods for managing deliberation experiences by providing an online deliberation platform that is integrated with a computer-based, expert moderator system.

An embodiment includes a deliberation experience system. The deliberation experience system includes a memory storing processor-executable instructions of a deliberation platform. The deliberation experience system also includes one or more processors communicatively coupled to the memory and configured to execute the processor-executable instructions from the memory. The one or more processors are configured, when executing the instructions, to: generate and provide a manager dashboard of the deliberation platform to a manager user device, wherein the manager dashboard is configured to present, on the manager user device, a list of participant user devices and a list of issue guides with topics for discussion in a plurality of forums of the deliberation platform; receive, via the manager dashboard, a first selection from the manager user device requesting assignment of a respective set of the participant user devices participants to each respective forum of the plurality of forums, and in response, communicatively couple the respective set of the participant user devices to each respective forum; receive, via the manager dashboard, a second selection from the manager user device selecting an issue guide from the list of issue guides, and in response, instruct a computer-automated moderator of the deliberation platform to moderate the discussions in the plurality of forums, wherein moderating comprises: transmitting each of the topics of the selected issue guide to the respective set of the participant user devices of each respective forum, processing received responses from the respective set of the participant user devices associated with each respective forum, and generating a respective representation of each respective forum based on the processing of the received responses; and present, via the manager dashboard, the respective representation of each respective forum on the manager dashboard.

An embodiment includes a process for managing a deliberation experience system for participant engagement. The process includes generating a deliberation platform having a plurality of forums communicatively coupled to a plurality of participant user devices, each forum of the plurality of forums including a chat window that displays messages from a subset of participant user devices. The process also includes receiving an indication of a selected issue guide from a manager user device. Additionally, the process includes providing an introduction portion and a first topic of the selected issue guide to the chat window of each forum. The process also includes receiving one or more messages in the chat window of each forum from the subset of participant user devices to enable automated moderation of discussion in each forum. The process further includes, in response to identifying a question in at least one message of the one or more messages, providing a first response to the question in the chat window of an associated forum of the plurality of forums. The process includes, in response to identifying a prohibited phrase in at least one message of the one or more messages, providing a second response to the prohibited phrase in the chat window of an associated forum of the plurality of forums. Moreover, the process includes, in response to a subsequent topic of the selected issue guide remaining, providing the subsequent topic to the chat window of each forum. The process also includes, in response to no subsequent topic of the selected issue guide remaining, providing a conclusion portion of the selected issue guide to the chat window of each forum.

An embodiment includes a non-transitory machine-readable storage medium of a deliberation experience system. The non-transitory machine-readable storage medium includes instructions executable by one or more processors, including instructions to: generate a deliberation platform including a plurality of forums and a manager dashboard to facilitate monitoring deliberation in each forum of the plurality of forums, the manager dashboard presented on a manager user device; receive a first input from the manager user device indicative of assigning a respective set of participant user devices to each forum and communicatively couple the respective set of participant user devices to each forum; receive a second input from the manager user device indicative of a selected issue guide of a plurality of issue guides, the selected issue guide including a plurality of discussion topics; receive a third input from the manager user device indicative of an allotted time period for deliberation, each discussion topic of the selected issue guide being associated with a respective portion of the allotted time period; instruct a computer-automated moderator to initiate a guided discussion on each forum by progressing through each discussion topic of the selected issue guide in each forum; and collect and present data associated with participant opinions from the respective set of participant user devices on one or more proposed actions of the selected issue guide on each forum.

Other aspects and features of the present disclosure will become apparent to those of ordinary skill in the art after reading the detailed description herein and the accompanying figures.

### BRIEF DESCRIPTION OF THE DRAWINGS

Embodiments will be readily understood by the following detailed description in conjunction with the accompanying drawings. To facilitate this description, like reference numerals designate like structural elements or procedures in a method. Embodiments are illustrated by way of example and not by way of limitation in the figures of the accompanying drawings.

FIG. 1 illustrates an example embodiment of a deliberation experience system for providing a framework to guide deliberation between participants on a deliberation platform, according to the embodiments of the present disclosure.

FIG. 2 is a schematic diagram of an example embodiment of the deliberation experience system, including the deliberation platform and a computer-automated moderator (CAM), according to the embodiments of the present disclosure.

FIG. 3 illustrates an example embodiment of an adaptive moderator system of the CAM, according to the embodiments of the present disclosure.

FIG. 4 illustrates an example embodiment of an abuse detection system of the CAM, according to the embodiments of the present disclosure.

FIG. 5 illustrates an example embodiment of a question answering system of the CAM, according to the embodiments of the present disclosure.

FIG. 6 depicts an example embodiment of a flow diagram for a process by which the deliberation experience system may prepare an issue guide for use in a forum, according to the embodiments of the present disclosure.

FIG. 7 illustrates an example embodiment of a flow diagram for a process by which the deliberation experience system may implement a manager dashboard to assign participants to forums, according to the embodiments of the present disclosure.

FIG. 8 includes an example embodiment of a representation of a participant assignment screen that may be displayed on a manager user device, according to the embodiments of the present disclosure.

FIG. 9 illustrates an example embodiment of a flow diagram for a process of using a previous participation adjuster of the adaptive moderator system, according to the embodiments of the present disclosure.

FIG. 10 illustrates an example embodiment of a flow diagram for a process by which the deliberation experience system may structure and pace deliberation in a forum, according to the embodiments of the present disclosure.

FIG. 11 illustrates an example representation of a forum screen that may be provided to participant user devices, according to the embodiments of the present disclosure.

FIG. 12 illustrates an example embodiment of a flow diagram for a process for operating the abuse detection system of the CAM shown in FIG. 4, according to the embodiments of the present disclosure.

FIG. 13 illustrates an example embodiment of a flow diagram for a process for operating the question answering system of the CAM shown in FIG. 5, according to the embodiments of the present disclosure.

FIG. 14 illustrates an example embodiment of a representation of a panoptic forum view on a manager dashboard that may be displayed on the manager user device, according to the embodiments of the present disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

As used herein, such as in some or all of the detailed description or one or more of the claims below, the phrase “at least one of A, B, or C” includes A alone, B alone, C alone, a combination of A and B, a combination of B and C, a combination of A and C, and a combination of A, B, and C. That is, the phrase “at least one of A, B, or C” means A, B, C, or any combination thereof such that one or more of a group of elements consisting of A, B and C, and should not be interpreted as requiring at least one of each of the listed elements A, B and C, regardless of whether A, B and C are related as categories or otherwise. Also, the recitation of “A, B and/or C” is equal to “at least one of A, B or C.” Furthermore, the use of the article “a” or “the” in introducing an element should not be interpreted as being exclusive of a plurality of elements. Indeed, the singular forms “a,” “an,” and “the” include plural referents unless the context clearly dictates otherwise. The use of “a” refers to “one or more” or “at least one” in the present disclosure. For example, “a module” refers to “one or more modules” or “at least one module.”

Provided herein are systems and methods for improved deliberation experiences via an online deliberation platform. For example, the present disclosure provides a deliberation experience system that includes an online deliberation platform that advances the state of the art of deliberation with various interwoven and symbiotic functionalities. The deliberation experience system may thus allow a manager to facilitate guided, small-group discussions on a wide variety of issues with a large group of participants and minimal human oversight. For example, as mutually reinforcing features, the deliberation experience system disclosed herein includes a scalable, online deliberation platform and an adaptive chatbot or moderator system to facilitate scalability and non-hierarchical management of deliberative forums on the deliberation platform. The deliberation platform achieves large-scale utilization and deployment, as well as offering users greater levels of control and customization. The adaptive chatbot may leverage artificial intelligence (AI) as a computer-automated moderator (CAM) that is capable of automating a vast majority of moderating duties, thus allowing managers of large groups of people to independently manage multiple forums with little to no prior training. In some embodiments, these adaptive techniques may be leveraged to provide valuable validation studies on deliberation itself, such as by facilitating the collection and analysis of data across a large number of deliberation forums over time.

With these concepts in mind, the deliberation experience system may produce a range of outcomes that further civic education and scholarly understanding of deliberation, including: (i) a fully scalable solution for facilitating small group deliberative forums in a variety of civics classroom situations; (ii) workshops and online materials for instructors interested in using the system, including a model curriculum around the system; and (iii) a series of issue guides that are integrated with the system on a wide range of topics, which may include controversial political issues covering domestic and international affairs.

As will be understood, the deliberation experience system disclosed herein may advance the state of the art in deliberation experiences in several ways. For example, the deliberation experience system may be designed and implemented as an online system tailored to individual managers. This adaption may involve several steps, such as: (i) permitting managers to enroll with and gain full access from the deliberation experience system directly, without going through an intermediary; (ii) designing a user-friendly interface, which managers can use to choose issue guides and start discussions with little to no previous experience on the deliberation experience system; (iii) providing live feedback, so managers be informed in real time whether a particular forum is having difficulty, has a pending, unanswered question, or is experiencing abusive behavior, thus allowing for prompt intervention; (iv) generating detailed analytics of the experience for the participants in the deliberation experience system, thereby providing effective and intuitive evaluation of participant performances; (v) enabling efficient organization of participants into small groups for discussion along several partitions or lines, such as with manual, random, and/or diverse processes; and (vi) allowing participants to join and participate in the controlled environment efficiently and intuitively. As such, instead of relying on intermediary supervisors and moderators of certain previous systems, the deliberation experience system enables a manager to conduct high-quality, small group discussions with professionally developed materials at any chosen time, with minimal to no preparation.

As a further benefit, the CAM of the deliberation experience system may significantly reduce a demand for user intervention by human moderators. For example, certain existing systems may include a human moderator in each forum, who is tasked with (1) copying and pasting commonly used phrases from a reference document to structure the conversation, (2) monitoring time between various transitions, (3) analyzing results of deliberation and adjusting the deliberation accordingly, (4) encouraging participation, (5) detecting and addressing any abuse, and (6) answering participant questions. By offloading or being delegated these tasks, the CAM allows the manager to oversee a large number of forums at once, with specific alerts generated in response to detection of a question for which the CAM is not programmed to answer, abusive behavior, and/or decreased interactions or participation from the participants. The CAM thus dramatically improves the scalability of the deployed deliberation experience system. The system of generated alerts may also permit the manager to provide and monitor a large number of forums simultaneously, with little to no previous training and without any human moderators.

When organizing the groups, a manager dashboard of the deliberation experience system also enables the manager to construct the groups in several ways. As participants enter or access the system, they may be queued for the manager to split or distribute into groups. The forum assignments may be entered manually by the manager, performed in a random manner, or performed in an “diverse” manner, which may promote diversity within the groups using demographic data and opinions on the actions to be discussed in the forum provided by the participants. The manager may provide any input to the deliberation experience system through the manager dashboard, which is communicatively coupled to each forum being managed by the deliberation experience system. The dashboard allows the manager panoptic access to all forums, such as via accessible tiles or modules on their screen. A manager can select a forum to monitor more closely at any time, and see alerts from one or more systems, such as an adaptive moderator system or script, an abuse detection system, and a question answering system, that may demand direct attention. The panoptic process thus ensures that the manager is able to effectively monitor their forums as participants deliberate on various topics. The direct supervision also encourages compliance with the norms of the forums as laid out in any provided instructions or curriculum.

The CAM may include several modules, which are introduced here and further described with reference to the figures. As an example, the CAM may include a database of issue guides, which each provide background material or structure for a particular discussion. In embodiments regarding civics education, for example, the issue guides may be structured along the lines of a National Issues Forums Institute (NIFI) issues guide, but modified and simplified to be appropriate for different grade levels and various lengths of discussion, which may fit into standard class times or other predetermined time intervals. Certain embodiments may include issue guides that cover a range of civic education and other topics. In embodiments, managers may make selections from a range of issue guides, which are then automatically updated in the deliberation experience system. Managers may also select between variants of issue guides that have different lengths of time, such as variants ranging from 30 minutes to 2 hours, to match with class or extracurricular times or other suitable activities having a predetermined duration.

The CAM also includes an adaptive moderator system as a proficient, expert system that simultaneously addresses multiple tasks that may have been previously performed by human moderators, such as points (1)-(4) above. The adaptive moderator system may draw information from the manager-selected issue guide and the events in the forum itself to structure the conversation in line with the selected issue guide, explain the process to participants, encourage “lurkers” to contribute, and temper “hyperactive” participants into turn-taking in the conversation. The adaptive moderator system may also adjust timing and transitions to accommodate groups that are either unusually active or unusually passive in posting comments, while adjusting transitions to expand or contract the discussion into the predetermined time period selected by the manager. In addition, the adaptive moderator system may adapt messages based on any repeat participants to avoid repetitious information provision. In some embodiments, the adaptive moderator system may also include or generate multiple different versions of scripted responses to avoid being viewed as overly formulaic or robotic by the participants. In certain embodiments, the moderator script may include multiple encouragement methods or prompts to directly encourage participation. Moreover, the moderator script may send a notification or alert to the manager via the manager dashboard in response to overall participation slowing to enable the manager to provide targeted encouragement to the participants. As additional modules for addressing points (5) and (6) above, the CAM may also include an abuse detection system for detecting and addressing any intentional or unintentional abuse or harassment, as well as a question answering system for identifying and answering participant questions during the deliberation experience.

The abuse detection system of certain embodiments may expand on several open AI libraries for detecting abusive language, hate speech, and/or negative sentiment in the discussions. The libraries may be specifically adjusted or tuned for the deliberation context, with a very low threshold for detecting abuse. As a non-limiting example provided for understanding, the comment “why should we spend this money on worthless towns” will not normally be flagged in an online abuse system, but is tagged by the present abuse detection system based on the negative connotation. Any tagged messages may then be evaluated, and an alert may be sent to the manager in response to the evaluation meeting one or more abuse criteria. Accordingly, the abuse detection system and/or the alerted manager may address any abusive language. In some embodiments, abusive behavior in deliberations hosted on online deliberation experience systems or platforms is extremely rare. Nevertheless, there are many instances of such abuse in online forums more generally, and this protection provides managers and participants piece of mind that any such negative experiences are not supported on the platform (or, at a minimum, that they can be readily addressed in real time). In addition to tagging outright abuse, sentiment analysis is used to track the overall tone of the conversation and send a notification to the manager when the tone is unusually negative.

The question answering system of certain embodiments includes an AI system trained on past forums, as well as a programmed transformer to address any novel variants of these questions. The question answering system may therefore detect questions from participants, classify them into categories based on the requested information, and provide responses including the requested information. The question answering system may also detect novel questions, such as those related to broader topics, and alert the manager that a question has been asked for which the question answering system does not have the requested information. Furthermore, each of these systems or modules may integrate with the forums and the manager dashboard for an integrated, constructive, and guided deliberation experience. With the above context in mind, further details are provided herein with reference to certain non-limiting examples of the deliberation experience system.

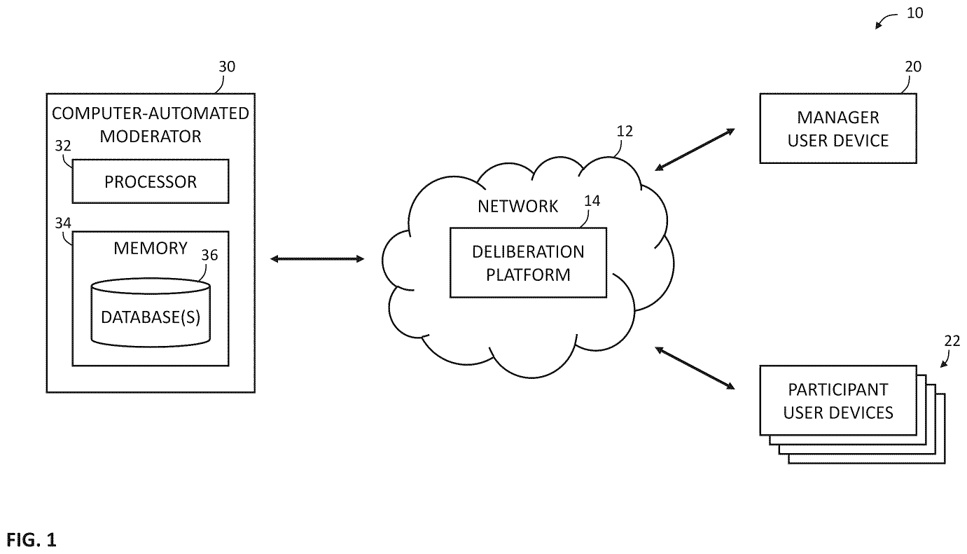

FIG. 1 illustrates an example embodiment of a deliberation experience system 10 that provides a framework for guiding deliberation between participants. The deliberation experience system 10 may include a network 12 that hosts a deliberation platform 14. As will be understood, the deliberation platform 14 facilitates meaningful discussion between participants in a manner that is more inclusive, unbiased, and effective than previously available mediums of discussion. The deliberation experience system 10 may include at least one manager user device 20 and multiple participant user devices 22 that are communicatively coupled to the network 12 and the deliberation platform 14 hosted thereon. For example, a single manager user device 20, associated with a user having a manager role, may be communicatively coupled to the network 12 to provide instructions and management of activities performed on the deliberation platform 14, in certain embodiments. Additionally, any suitable number of participant user devices 22 associated with users having participant roles may be included in the deliberation experience system 10 to extend associated deliberations across a wide span of participants, in embodiments. The user devices 20, 22 may include any suitable wired or wireless devices capable of communicatively coupling to the network 12. For example, in some embodiments, the user devices 20, 22 include personal computers, laptops, mobile devices, smart phones, tablets, and so forth. Accordingly, participants may access the deliberation experience system 10 through their preferred participant user devices 22 to engage in guided deliberation on various topics with one another, while the manager oversees discussions from his or her preferred manager user device 20.

As used herein, a “manager” refers to an individual that controls, supervises, and/or moderates deliberations hosted on the deliberation platform 14. A “participant” as referred to herein refers to an individual that participates in one or more deliberations hosted on the deliberation platform 14. For example, in embodiments associated with an educational course or a classroom, the manager may be an instructor and the participants may be students. As another example, in embodiments associated with a corporate environment, the manager may be a supervisor and the participants may be employees. In other examples associated with a political environment, the participants may be a group of politicians and the manager may be a person with a leadership role over the group. As further illustration, the participants may be users on equal standing with one another, and the manager may be any suitable user assigned to supervise interactions between the participants. It should be understood that the presently disclosed deliberation experience system 10 is not limited to any particular environment and, instead, may be implemented with any suitable group or population of people as participants and at least one managing user as the manager.

As illustrated, the deliberation experience system 10 includes a moderator system, virtual moderator, or a computer-automated moderator (CAM) 30 that is communicatively coupled to the network 12. In embodiments, the CAM 30 may be communicatively coupled to, hosted by, and/or integrated with the deliberation platform 14. The CAM 30 may include at least one processor 32 and at least one memory 34, which may contain or access any suitable number of databases 36. In some embodiments, the databases 36 may be additionally or alternatively maintained within the deliberation platform 14. The memory 34 may include or store instructions executable by the processor 32.

As used herein, a “processor”, processing resource, or processing circuitry may be a plurality of processors connected together in communication with an electronic communications network. In other embodiments, the processors may be a group of graphical processing units configured to work in parallel as a graphics processing unit (GPU) cluster. A processor may include a single processor device and/or a plurality of processor devices, such as distributed processors. Additionally, a processor may be any suitable processor capable of executing/performing instructions. For example, a processor may include a central processing unit (CPU), a semiconductor-based microprocessor, a GPU, a field-programmable gate array (FPGA) to retrieve and execute instructions, and/or a real-time processor (RTP) that carries out program instructions to perform the basic arithmetical, logical, and input/output operations required to support the deliberation experience system 10. A processor may include code, such as processor firmware, a protocol stack, a database management system, an operating system, or a combination thereof, that creates an execution environment for program instructions. Processes and logic flows described herein may be performed by one or more programmable processors executing one or more computer programs to perform functions by operating on input data and generating corresponding output.

In an example, the memory 34 may be a non-transitory machine-readable storage medium. As used herein, a “machine-readable storage medium” may be any electronic, magnetic, optical, or other physical storage apparatus or cyber-physical separation storage to contain or store information such as executable instructions, data, and the like. For example, any machine-readable storage medium described herein may be any of random-access memory (RAM), volatile memory, non-volatile memory, flash memory, a storage drive such as hard drive, a solid-state drive, any type of storage disc, and the like, or a combination thereof. As noted, the memory 34 may store or include instructions executable by the processor 32. Accordingly, the processor 32 may execute machine-readable instructions of the memory 34 to provide enhanced deliberation experiences on the deliberation platform 14, as discussed in more detail below.

As presently recognized, the CAM 30 is communicatively coupled to the deliberation platform 14 to guide discussions thereon, such as based on one or more instructions received from the manager user device 20. The CAM 30 includes multiple features or modules that deliver robust and reliable group deliberations, as discussed in more detail below. Moreover, the CAM 30 may support an extensive number of participants that is greatly increased relative to any previously available discussion systems, while reducing or even eliminating a demand for training and using human moderators in each group of participants. In other words, present embodiments of the deliberation experience system 10 are scalable to support any desired number of forums, which each include a respective group of participants therein. These forums may each be moderated or managed by the CAM 30, which may request input from the manager only under limited, specific circumstances. As such, a single manager using the deliberation experience system 10 may be empowered to address any high-level issues within a correspondingly increased number of forums. As non-limiting examples, the manager may supervise ten, twenty, fifty, or more forums, each including at least eight, ten, twelve, or more participants, by leveraging the automated functionalities of the CAM 30. In some embodiments, each forum may include twelve or less participants.

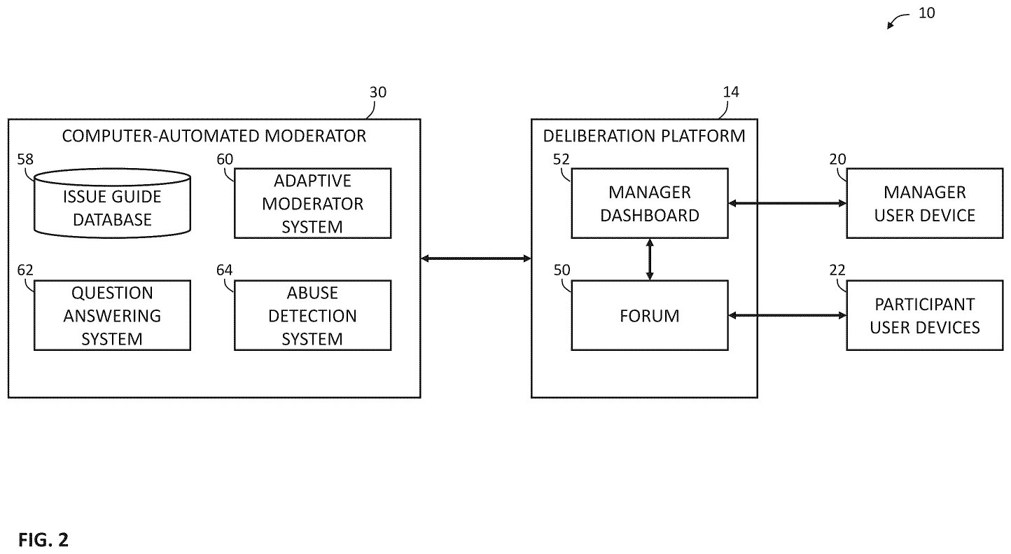

FIG. 2 is a schematic diagram of an example embodiment of the deliberation experience system 10, illustrating further functionality of the deliberation platform 14 and the CAM 30. In some embodiments, the deliberation platform 14 includes a forum 50 and a manager dashboard 52 that efficiently governs user interactions on the forum 50, which may be one of multiple forums 50 simultaneously active within the deliberation experience system 10. For example, the manager user device 20 may interact with the deliberation platform 14 through the manager dashboard 52, which provides instructions or commands to the forum 50 based on user input from the manager. The forum 50 may include a text chat window that enables participants to interact with each other and with the CAM 30. In some embodiments, the forum 50 may also include a polling system that facilitates collection of participant input regarding opinions on discussion topics, demographic information, and/or feedback on the deliberation experience. The forum 50 may further include a graphical modeling system to display data or representations to augment a current deliberation, in embodiments.

As illustrated, the CAM 30 may include multiple components or systems that enable the CAM 30 to efficiently guide discussion on the forum 50. For example, the present example of the CAM 30 includes an issue guide database 58, an adaptive moderator system 60, a question answering system 62, and an abuse detection system 64. The components of the CAM 30 are introduced below for clarity and further operations thereof are described with reference to later figures.

For example, the issue guide database 58 of the CAM 30 may include a repository of multiple digital issue guides that may each include a corresponding topic issue, issue explanation, options for policies, and/or explanations of actions, in some embodiments. In some embodiments, the issue guide database 58 includes one or more issue guides that are directed to civic education topics. The CAM 30 may retrieve a selected issue guide from the issue guide database 58 in response to receiving a selection from the manager user device 20, in some embodiments. The adaptive moderator system 60 of the CAM 30 may include multiple components with selectively adjusted interactions therebetween that manage a pace and content of deliberation, such as based on a currently active or selected issue guide. Operating concurrently with the adaptive moderator system 60, the question answering system 62 of the CAM 30 may include programming to detect questions within messages provided by participants, providing answers to the questions if the CAM 30 is able to determine the answers, and transmitting alerts to the manager user device 20 if the CAM 30 is not able to determine the answers. Additionally, certain embodiments of the CAM 30 include the abuse detection system 64 to respond to and/or report messages associated with abusive or obscene language, while monitoring an overall sentiment of discussion. As such, the abuse detection system 64 may intervene or request intervention from the manager in response to determining that the sentiment is declining or has declined beyond a suitable threshold within a particular forum.

In embodiments, the adaptive moderator system 60, the question answering system 62, and the abuse detection system 64 are operating simultaneously or in parallel within each one of the forums 50 of the deliberation platform 14. Moreover, the systems 60, 62, 64 may operate with respective levels of priority to address any participant concerns, while maintaining an effective deliberation experience. For example, in some embodiments, the abuse detection system 64 may be assigned a highest priority, such that a message with inappropriate content is addressed via a suitable corrective action as soon as possible, regardless of whether the message included a question. In some embodiments, the question answering system 62 may be assigned a priority that is higher than, equal to, or lower than a priority of the adaptive moderator system 60, based on specific manager instructions or expectations regarding a particular issue guide, participant base, or length of time provided for deliberation, for example.

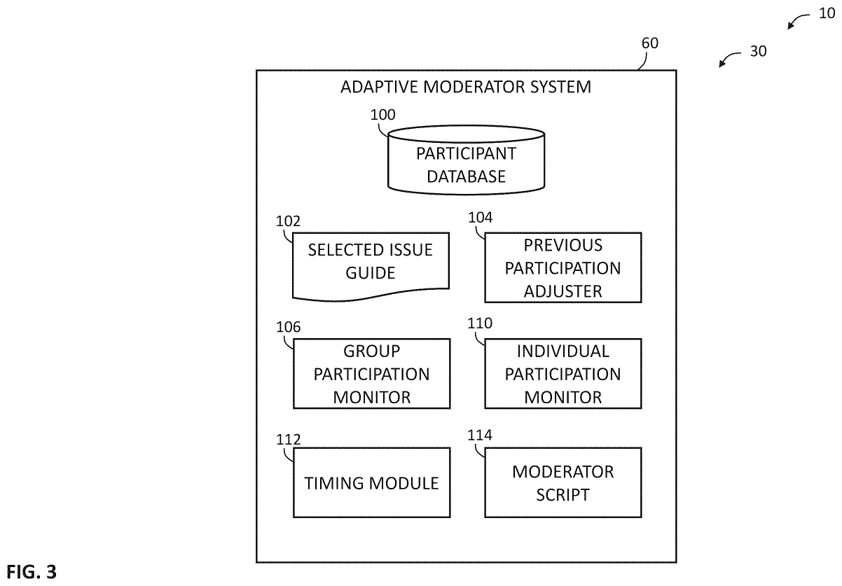

Looking to the adaptive moderator system 60 of the CAM 30 in more detail, FIG. 3 illustrates an example embodiment of multiple components or functionalities that may be provided therein. For example, the adaptive moderator system 60 may include a participant database 100, a selected issue guide 102, a previous participation adjuster 104, a group participation monitor 106, an individual participation monitor 110, a timing module 112, and a moderator script 114, or any combination thereof. Although illustrated as individual components, it should be understood that the components of the adaptive moderator system 60 may be combined in any suitable manner and/or certain components may be omitted. As noted, the selected issue guide 102 may be identified and retrieved based on input received from the manager user device 20. In some embodiments, the selected issue guide 102 may be provided to or retrieved by the adaptive moderator system 60 in any suitable process, such as by querying the issue guide database 58 introduced above. The moderator script 114 of the adaptive moderator system 60 may therefore parse or digest the selected issue guide 102 into a baseline series or sequence of messages to be provided to each forum for structuring conversation. In some embodiments, the selected issue guide 102 may be retrieved in a format that already includes various messages divided and/or timestamped for sequential provision to the text chat window. In embodiments, the moderator script 114 may further adjust the pacing and content of deliberation based on data or instructions received from other components of the adaptive moderator system, such as the timing module 112. As such, the moderator script 114 may incorporates the issue guide and provide general instructions and guideposts for participants.

The participant database 100 of certain embodiments may include a repository of multiple participant profiles, which may each include relevant information about the participants and their respective involvement with the deliberation experience system 10. The participant database 100 of some embodiments may be encrypted or protected via any suitable security protocols. As example data entries, the participant profile of each individual may include identification information such as a name, contact information, educational course identifier, student identification number, employee identification number, business section or group, and/or any other information that may serve to differentiate participants from one another. In some embodiments, the participant database 100 may be populated with information received from a questionnaire or survey, including the identification information, certain preferences, demographics, or combinations thereof. In embodiments, the participant database 100 tracks and/or stores the individual participation, comments, and timing for each participant, while also maintaining data or reports for group participation, individual participation, and group experience.

The participant database 100 may include information associated with any previous sessions of the participants within the deliberation experience system 10, in some embodiments. For example, the adaptive moderator system 60 may assign participants with a familiarity level, such as a tag or a score, that indicates a degree to which a participant is familiar with the deliberation experience system 10. The participant database 100 may also store information in respective participant profiles indicative of a number and/or topic of any issue guides for which the participants previously completed a deliberation experience. The previous participation adjuster 104 of the adaptive moderator system 60 may evaluate the familiarity level of the participants with the deliberation experience system 10 to selectively adjust an introduction portion of the deliberation, in some embodiments. As such, participants that are more familiar or experienced with the process may be provided with an abridged or shortened introduction portion having fewer instructions, which may beneficially conserve or save participant time within the forum for additional deliberation in place of a full introduction portion.

In some embodiments, the group participation monitor 106 may track and evaluate a general activity level of a group of participants within respective forums after deliberation has been initiated. As such, prompts may be provided to encourage participation of a group within its particular forum, such as in response to participation being below a predefined threshold. As a counterpart or parallel component to the group participation monitor 106, the individual participation monitor 110 may likewise track and evaluate an individual activity level of each participant. This individualized, fine-grain monitoring thus allows the adaptive moderator system 60 to prompt each user toward a target level of participation. The target level or range of participation may be frequent enough to indicate a suitable participation level, without domineering the deliberation or negatively impacting other participants' experience. As a non-limiting example, the target level of participation may range from one to three messages per provided question. As another example, the target level of participation may include at least one message per predetermined time period. A further example may include a target level of participation being reached in response to a participant sending a first message and waiting for one or more other participant messages before sending a second message.

The timing module 112 may provide the moderator script 114 with time-based instruction data, in some embodiments. For example, the timing module 112 may receive a length of time provided for deliberation from the manager dashboard, and assign various portions of the available time to portions of the selected issue guide. As non-limiting examples, a shorter time period may be provided between messages from the adaptive moderator system 60 when instructional or background information is being provided, compared to a longer time period between messages associated with user input from the participants being requested, a deliberative question being provided, and so forth. The timing module 112 may include one or multiple timers to assist the moderator script 114 with proper pacing of the messages provided to the forums, in certain embodiments. Additionally, certain embodiments of the timing module 112 may receive an intensity or frequency of participation from the group participation monitor 106, and implement this data for pacing the deliberation. For example, the timing module 112 may slow down the forum to allow for deeper discussion of active issues associated with a suitably high discussion intensity. Additionally, the timing module 112 may speed up or transition to a subsequent topic in response to discussion of issues associated with a low discussion intensity or high repetitiousness.

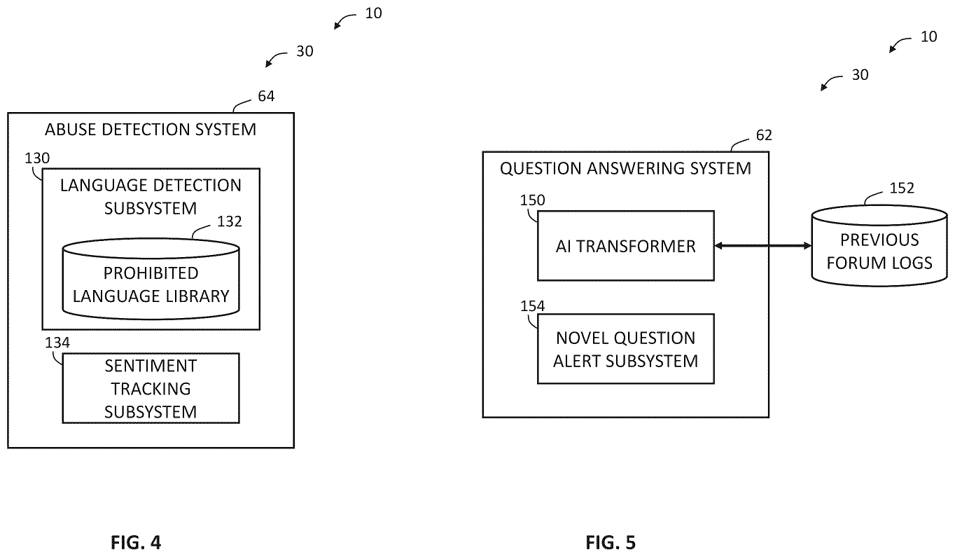

FIG. 4 illustrates an example embodiment of the abuse detection system 64 of the CAM 30. In some embodiments, the abuse detection system 64 includes natural language processing (NLP) features to facilitate evaluation of forum messages provided by participants. The abuse detection system 64 may include a language detection subsystem 130 that reviews forum messages for any prohibited language. Certain embodiments of the language detection subsystem 130 include or have access to a prohibited language library 132. The prohibited language library 132 may include words, phrases, symbols, and so forth that are prohibited or blacklisted from inclusion in forum messages. In certain embodiments, the prohibited language library 132 utilizes a machine learning system that is trained on discussion data and generates a probability score indicative of a likelihood that a current message contains abusive language. For example, the discussion data might be sourced from one or more suitable online forums or social media sites. As such, the abuse detection system 64 may prohibit or flag messages having respective probability scores that are above a threshold. In some embodiments, the prohibited language library 132 may be customized by the manager based on individual additions or subtractions therefrom. In some embodiments, the abuse detection system 64 may include multiple versions of prohibited language libraries 132 for the manager to select from, such as based on the participants' educational level, age, and/or issue guide to be discussed. As an example, certain words and phrases may be prohibited for participants that are below a predetermined age, but allowed for participants of or above the predetermined age. As another example, certain language that is generally controversial may be prohibited during most deliberations, but allowed when deliberation of a topic is expected to encompass the controversial language.

The illustrated embodiment of the abuse detection system 64 also includes a sentiment tracking subsystem 134 to provide further robustness to the moderation of forums within the deliberation platform 14. The sentiment tracking subsystem 134 may monitor or evaluate a general sentiment within each forum, thereby facilitating intervention or encouragement in response to a determination that the sentiment of discussion is overly negative. The sentiment may be determined based on NLP of the forum messages, in some embodiments. In embodiments, the sentiment tracking subsystem 134 may therefore identify certain messages that do not include any specifically prohibited language, but otherwise include inflammatory statements, non-constructive criticism, creative insults, or other overly negative topics.

FIG. 5 illustrates an example embodiment of the question answering system 62 of the CAM 30. The question answering system 62 may identify and resolve questions within messages received from participant user devices 22, in some embodiments. The question answering system 62 may include an AI transformer 150 that, in some embodiments, is trained based on a database or corpus of previous forum logs 152. The previous forum logs 152 may be stored and supplemented with logs of additional deliberation sessions after their completion on the deliberation platform. In some embodiments, the previous forum logs 152 may additionally or alternatively be imported from other sources, such as transcripts of in-person deliberations, a manager-provided document of commonly asked questions and their answers, a syllabus, an employee guidebook, and so forth. As non-limiting examples, the previously answered questions may include off-topic questions that are not directly related to the selected issue guide, such as questions that participants may have regarding assignments, grades, time remaining, holidays, or other issues. As such, the AI transformer 150 may be trained to provide answers to questions that have been encountered previously, freeing the manager for completion of more managerial and less routine activities.

The question answering system 62 may also include a novel question alert subsystem 154, operating in parallel with the AI transformer 150. The novel question alert subsystem 154 may provide an alert to the manager user device in response to determining that an answer to a detected question is not known. The alert may include an indication of a novel question in a particular forum, in some embodiments, thereby prompting the manager to join the particular forum from the manager dashboard and answer the question. In some embodiments, the alert may include a reproduction or representation of the novel question and a response text box, such that the manager may provide an answer to the response text box from the manager dashboard for the CAM 30 to relay to the forum. With the above description of components of the deliberation experience system 10 in mind, further examples are described below to illustrate the operation and interconnection of the components.

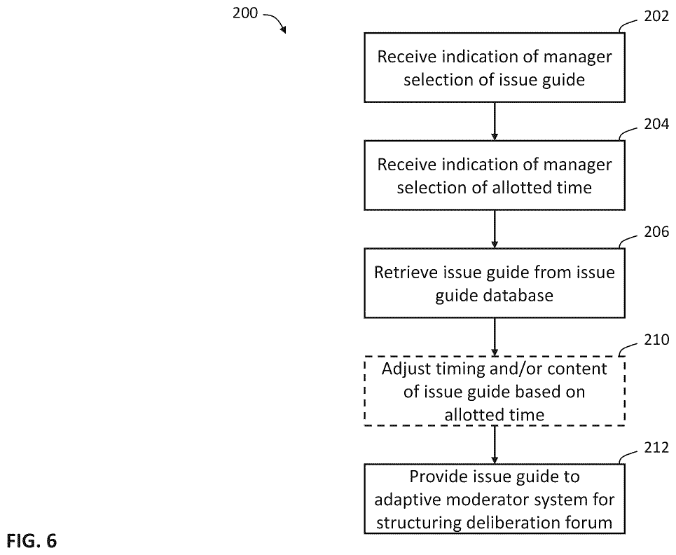

FIG. 6 depicts an example embodiment of a flow diagram for a process 200 by which the deliberation experience system 10 or CAM 30 thereof may prepare an issue guide, before one or more forums are initiated in the deliberation platform. The example process 200 is illustrated as a collection of blocks in a logical flow graph, which represents a sequence of operations. The order in which the operations are described is not intended to be construed as a limitation, and any number of the described blocks may be combined in any order and/or in parallel to implement the process 200.

At block 202, the deliberation experience system 10 may receive an indication of a manager selection of an issue guide. For example, via the manager dashboard 52 accessible to the manager user device 20, the deliberation platform 14 may display a list of available issue guides from which the manager may select. In some embodiments, the displayed list may include each issue guide stored within the issue guide database 58. The displayed list of some embodiments may be filtered based on parameters provided from the manager user device 20, such as a suggested age range, a category or subcategory of issue guides, an indication of previous issue guides selected or favorited by the manager, and so forth. In some embodiments, the deliberation experience system 10 may also include functionality that the manager may use to upload a new issue guide to the issue guide database 58, which may then be selected by the manager for structuring a deliberation.

At block 204, the deliberation experience system 10 may receive an indication of manager selection of an allotted time for deliberation. In some embodiments, the allotted time may correspond to a length of a class period, such as 50 minutes, 60 minutes, 80 minutes, 90 minutes, 120 minutes, and so forth. In some embodiments, the allotted time may correspond to a length of all or a portion of a work shift at a business. The allotted time of some embodiments may be individually selected by the manager as any suitable length of time, such as by selecting a value from a drop-down list or by inputting numerical values into a numerical field on the manager dashboard 52. For example, the manager may type or otherwise provide a numerical value indicative of a desired length of time for deliberation. In some embodiments, the manager may also indicate when and/or for how long any breaks, pauses, or intermissions may be provided during deliberation.

At block 206, the deliberation experience system 10 may retrieve the selected issue guide from the issue guide database 58. For example, using the indication of manager selection or a suitable identifier, the CAM 30 may query the issue guide database 58 therein to retrieve the selected issue guide. In some embodiments, the issue guide database 58 may include multiple versions of each issue guide, each version corresponding to a predetermined time period for deliberation.

Optionally, at block 210, the deliberation experience system 10 may adjust the timing and/or the content of the selected issue guide based on the allotted time. For example, in certain embodiments, the issue guide database 58 may include multiple transformation layers or selectively-applicable modifiers that adjust an issue guide from a default time period to an adjusted time period corresponding to the manager-provided indication of allotted time for deliberation. In certain embodiments, the CAM 30 may adjust the content of the issue guide by increasing or decreasing a number of topics therein to correspond to the allotted time more closely. As an example, an issue guide may include portions therein that are denoted or tagged with various priorities, such as high priority, medium priority, and low priority. A default version of the issue guide may include the high priority and medium priority portions. Then, to adjust to a longer allotted time, the CAM 30 may add in one or more low priority portions. Alternatively, the adjust to a shorter allotted time, the CAM 30 may remove the medium priority portions, such that the resulting issue guide includes only the high priority portions. In some embodiments, portions of issue guides may be assigned with varying degrees of priority or importance that range across two, three, four, five, six, or more levels. Indeed, it should be understood that the issue guide may be adapted for various time periods in any suitable manner and not limited to the particular examples provided here.

After the adjustment, certain embodiments of the CAM 30 may store the adjusted issue guide in the issue guide database 58, thus making them available for future selection. In other embodiments, the issue guide may already correspond to the allotted time, such as by default or from an initial selection of a particular issue guide associated with the desired allotted time, and block 210 may be omitted. At block 212, the deliberation experience system 10 may therefore provide the issue guide having the selected allotted time to the adaptive moderator system 60. As detailed with reference to later figures, the adaptive moderator system 60 may implement the issue guide as guidelines or a script, such as the moderator script 114, for structuring deliberation experiences within the forums 50.

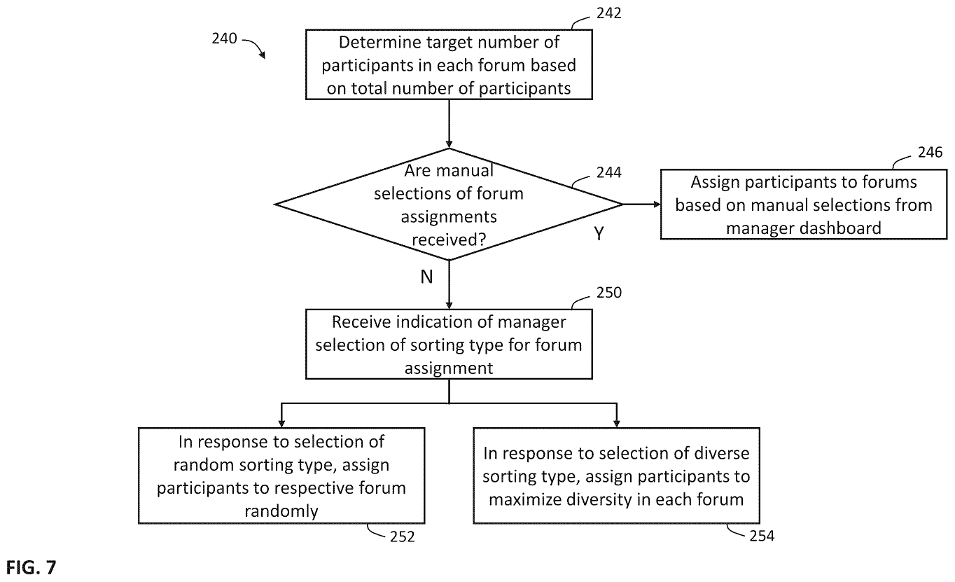

FIG. 7 illustrates an example embodiment of a flow diagram for a process 240 by which the deliberation experience system 10 may implement the manager dashboard 52 to assign participants to respective forums. The example process 240 is illustrated as a collection of blocks in a logical flow graph, which represents a sequence of operations. The order in which the operations are described is not intended to be construed as a limitation, and any number of the described blocks may be combined in any order and/or in parallel to implement the process 240.

At block 242, the deliberation experience system 10 may determine a target number of participants in each forum 50, such as based on a total number of participants that are currently logged onto the deliberation experience system 10. That is, the deliberation experience system 10 may determine a target number of participants to be provided in each individual forum via a dynamic analysis of the total number of logged in or online participants. It should be understood that the target number of participants may be determined in other manners, in certain embodiments, such as based on user input via the manager dashboard 52. The deliberation experience system 10 may generally equalize the number of participants across each forum. For example, the deliberation experience system 10 may divide the total number of participants by the target number for each individual forum to determine a number of forums having the target number of participants. For any remaining participants, the deliberation experience system 10 of certain embodiments may distribute them across other forums to provide a first portion of forums with the target number of participants and a second portion of the forums with one additional participants. This operation may provide more reliable deliberation experiences for participants, compared to situations in which a forum includes less than the target number of participants.

At block 244, the deliberation experience system 10 may determine whether manual selections of forum assignments are received from the manager dashboard 52. In response to manual selections being received, at block 246, the deliberation experience system 10 may assign participants to forums based on manual selections from the manager dashboard 52. For example, the manager may be presented with a user interface on the manager dashboard 52 to facilitate distribution of participants into forums. In embodiments, the user interface may include any suitable format for receiving individual selections of forum assignments from the manager user device. For example, the user interface may include a list of slots for participant profiles to be dragged and dropped from a participant list into respective forums by the manager. The user interface may additionally or alternatively allow selections of forum assignments by highlighting one or more participant profiles and designating a forum for participants associated with the one or more participant profiles.

In response to manual selections not being received, at block 250, the deliberation experience system 10 may receive an indication of manager selection of a sorting type for forum assignment. Certain embodiments may include automated sorting algorithms that distribute the participants into forums based on one or more instructions received from the manager. For example, at block 252, the deliberation experience system 10 may, in response to selection of a random sorting type or random assignment type, assign participants to respective forum groups randomly. The deliberation experience system 10 using the random sorting type may use any suitable random number generation processes to randomly distribute the participants, without consideration of their participant profiles. The random distribution may thus efficiently assign a large number of participants to forums in a manner that is independent of any qualities of the participants, other than their overall number. The random distribution may be repeated in certain embodiments if the selection of the random sorting type is repeated.

At block 254, the deliberation experience system 10 may, in response to selection of a diverse sorting type or diverse assignment type, assign participants to maximize diversity in each forum. The diverse sorting type may consider one or more parameters or variables of the participant profiles and disperse the participants in forums to provide each forum with a selection of participants having different values for the parameters or variables. As an example, the deliberation experience system 10 using the diverse sorting type may detect from the participant profiles that half of the participants identify as female and half of the participants identify as male, so each forum group may be constructed with half female and half male participants to approximate this distribution. As another example, the diverse sorting type may detect that one third of the participants identify with a first political party, two thirds of the participants identify with a second political party, half of the participants provided initial input agreeing with a proposition, and half the participants provided initial input disagreeing with the proposition. The deliberation experience system 10 of this example may sort the participants into forums to closely approximate the metrics of the population of participants based on these two variables, such that each forum includes around one third of participants identifying with the first political party and around half of participants initially agreeing with the proposition. In embodiments, the diverse sorting type promotes demographic and issue opinion diversity.

In embodiments, the diverse sorting type may consider one or multiple variables of the participants in any suitable priority, which may be based on default settings or individual adjustments provided by the manager. Indeed, the manager may customize the sorting criteria in any suitable manner to result in more diverse forum groups, in certain embodiments. For example, the deliberation experience system 10 may consider the initial opinion of a proposition and the identification with a particular political party as primary variables that the diverse sorting type will prioritize simultaneously to match subsets of the participants most closely in respective forums with the overall participant population. The deliberation experience system 10 may then consider other data, such as one or more of an age, a gender, a cultural background, a college major, an employee position title, and so forth, as secondary variables that will distribute within forums, contingent on the primary variables being distributed. As a further example, the diverse sorting type may consider one or more first variables of the participants as a high priority for diversifying across forums, one or more second variables as a medium priority for diversifying across forums, and one or more third variables as a low priority for diversifying across forums. The diversification settings may be updated or customized for each particular issue guide, in some embodiments. These non-limiting examples of assigning participants are provided to bring clarity to features of the deliberation experience system 10, which may include any suitable number of variables at any respective levels of priority for diverse sorting of participants.

Certain embodiments may include additional, manager-provided distribution rules, such as rules indicating that a particular group of participants are to be assigned to different forums for improved forum experiences. This feature may be implemented to, for example, break up groups of participants that are previously known to be close friends or to not get along with one another, thus equalizing the forum groups to a more neutral disposition. In embodiments, the additional distribution rules may be implemented during any suitable random sorting type or diverse sorting type.

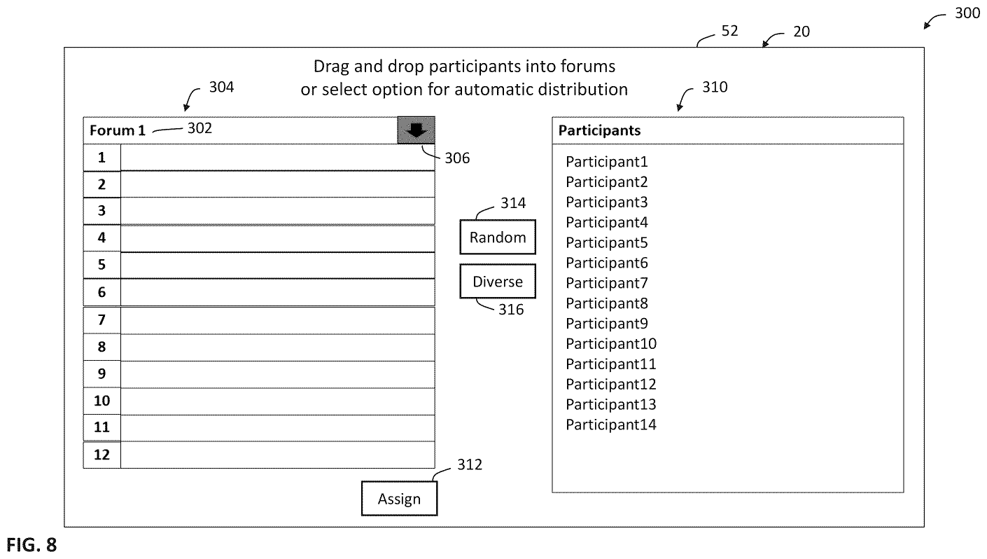

As an example, FIG. 8 includes a representation of a participant assignment screen 300, provided on the manager user device 20 by the manager dashboard 52 introduced above. The participant assignment screen 300 may include a forum identifier 302, which is associated with a roster 304 or list of seats for the particular identified forum. In some embodiments, user selection of an interactive button 306 adjacent the forum identifier 302 may provide a list of other forum identifiers, from which the manager may select to present associated rosters. The participant assignment screen 300 may also include a participant listing 310 indicative of participants that are awaiting assignment to respective forums. The participant listing 310 may fill with participant names in response to the participants signing or logging on to the deliberation platform, in some embodiments. In embodiments, the participant listing 310 may fill with the participant names in response to previous confirmation of the participants agreeing to engage with the deliberation platform. In such cases, the manager may complete a preliminary sort of the participants into forums, which may then be finalized based on the participants that sign or log on to the deliberation platform.

In embodiments, the participant assignment screen 300 enables the manager to drag participant names from the participant listing 310 and to the roster 304 of a particular forum. In some cases, the manager may fill the roster 304 with the desired participants in this manner, and then select a manual assignment button 312 of the participant assignment screen 300 to indicate the participant assignment for the current displayed roster 304 of a forum is complete. The participant assignment screen 300 may thus present the next empty roster 304 and associated forum identifier 302 for manual filling. In embodiments, each forum may be iterated through in this manner until each participant has been manually assigned to a respective forum.

In some embodiments, the participant assignment screen 300 includes a random assignment button 314 and/or a diverse assignment button 316. User selection of the random assignment button 314 may randomly distribute participants from the participant listing 310 into respective rosters 304. Alternatively, user selection of the diverse assignment button 316 may distribute participants from the participant listing 310 into respective rosters 304 based on diverse sorting algorithms discussed above. In some embodiments, the participant assignment screen 300 may enable manual adjustment of the rosters 304 after a random sort or a diverse sort is performed. For example, the manager may select a participant name from the roster 304 and assign the participant to an alternative forum identifier 302. It should be understood that the particular contents and positioning thereof on the participant assignment screen 300 are provided as examples, and features may be combined, omitted, or augmented with additional features to enable the deliberation experience system 10 to proficiently distribute participants into forums.

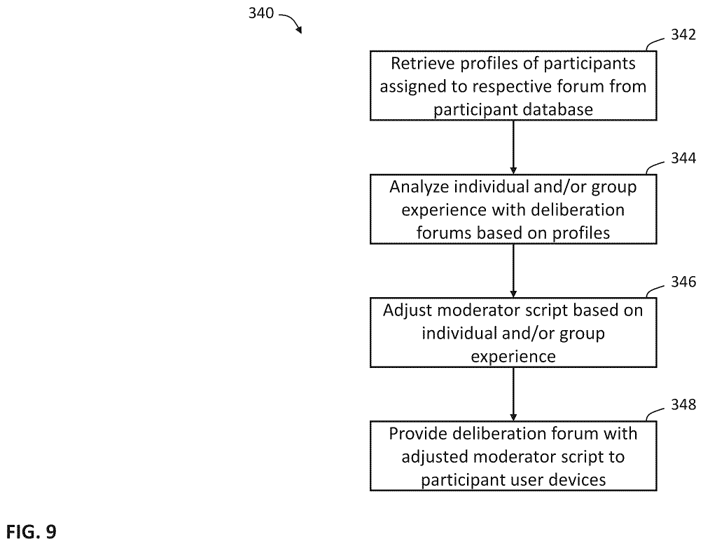

FIG. 9 illustrates an example embodiment of a flow diagram for a process 340 by which the adaptive moderator system 60 may implement the previous participation adjuster 104, as discussed with reference to FIG. 3, to adjust or refine the moderator script 114 based on any related participant experience with the deliberations. The example process 340 is illustrated as a collection of blocks in a logical flow graph, which represents a sequence of operations. The order in which the operations are described is not intended to be construed as a limitation, and any number of the described blocks may be combined in any order and/or in parallel to implement the process 340.

At block 342, the deliberation experience system 10 may retrieve profiles of participants assigned to a respective forum from the participant database 100. As noted above, participant profiles in the participant database 100 of some embodiments may include information associated with any previous sessions of the participants within the deliberation experience system 10, information indicating a familiarity level of each participant with the deliberation experience system 10, and/or any other data indicative of participant knowledge of the deliberation experience system 10.

At block 344, the deliberation experience system 10 may analyze any individual and/or group experience with deliberation forums, such as the forums 50, based on the retrieved participant profiles. In some embodiments, the deliberation experience system 10 may determine whether an individual participant is experienced or knowledgeable with deliberation forums based on the familiarity level of the participant profile being above a threshold familiarity, based on a participant-provided indication that preliminary instructions were read, based on a manager-provided indication that the participant is experienced with deliberation forums, and so forth. To evaluate group experience, the deliberation experience system 10 of some embodiments may determine whether a threshold percentage of the participants in the forum have previously completed a threshold number of deliberation sessions. In embodiments, the threshold percentage of the participants and/or the threshold number of deliberation sessions may be adjusted or customized by the manager. For example, the manager may specify that the group of participants is to be considered experienced or knowledgeable in response to 50 percent, 75 percent, or 100 percent of the participants having completed at least one previous deliberation session.

At block 346, the deliberation experience system 10 may adjust a moderator script 114 associated with the selected issue guide based on the individual and/or group experience of the participants in the forum. For example, in response to determining that individual and/or group participant experience with deliberation forums is suitably high or above a threshold, the deliberation experience system 10 may generate or identify an adjusted version of the moderator script 114 adapted to the experienced participants. In embodiments, the adjusted moderator script 114 may include an abridged or shortened introduction portion and reduced guidance for participation throughout.

At block 348, the deliberation experience system 10 may provide the deliberation forum with the adjusted moderator script 114 to the participant user devices 22. Thus, for participants with previous deliberation knowledge, the deliberation experience system 10 may enable conservation of the allotted time for more active engagement and messaging regarding topics in the selected issue guide. Alternatively, in response to determining the individual and/or group experience with deliberation forums is below the threshold or otherwise indicative of an increased demand for guidance, the deliberation experience system 10 may provide the associated forum with a normal or expanded version of the moderator script 114 or an introduction portion thereof, thus supporting forum engagement across various experience levels.

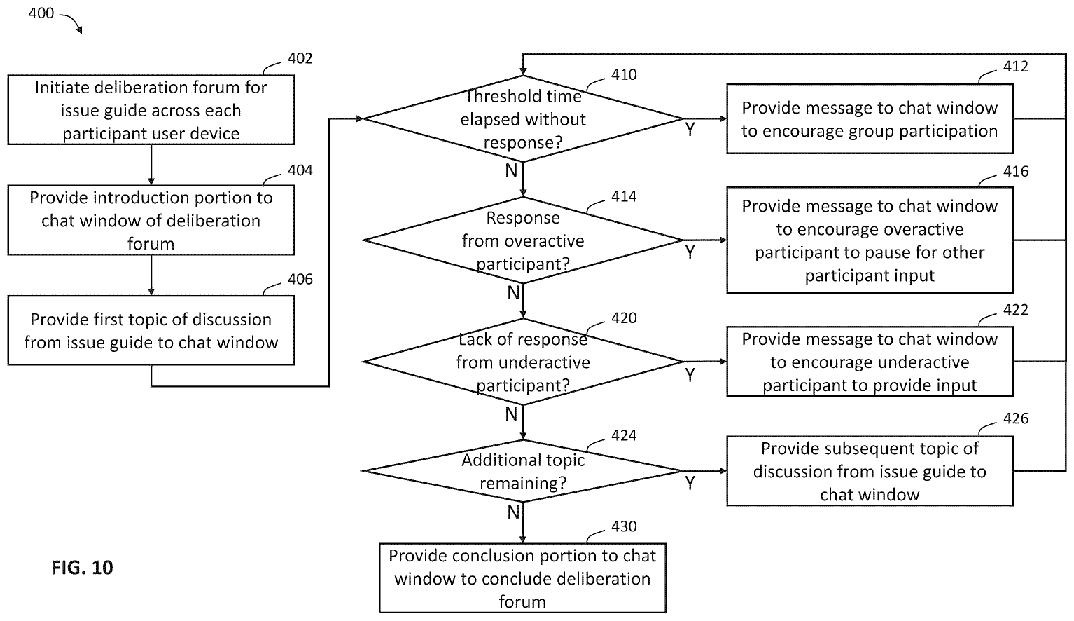

FIG. 10 illustrates an example embodiment of a flow diagram for a process 400 by which the deliberation experience system 10 or the CAM 30 thereof may structure and pace deliberation in a forum. In certain embodiments, the CAM 30 implements the adaptive moderator system 60, question answering system 62, and/or the abuse detection system 64 introduced above with reference to FIGS. 2-5 to perform the following operations. The example process 400 is illustrated as a collection of blocks in a logical flow graph, which represents a sequence of operations. The order in which the operations are described is not intended to be construed as a limitation, and any number of the described blocks may be combined in any order and/or in parallel to implement the process 400.

At block 402, the deliberation experience system 10 may initiate the forum 50 or deliberation forum for the selected issue guide across each participant user device 22 associated with participants assigned to a same forum. For example, the deliberation experience system 10 may initiate the forum 50 by providing access to the forum to each participant user device 22 coupled to the deliberation platform 14 or the network 12. In some embodiments, the deliberation experience system 10 may initiate the forum 50 in response to receiving a start signal from the manager user device 20. In certain embodiments, the forum 50 may be initiated in response to the deliberation experience system determining that a predetermined start time has been reached. The deliberation experience system 10 of certain embodiments may initiate the forum 50 in response to the participant user device 22 of each assigned participant being communicatively coupled to the deliberation platform 14 or the network. Additionally, the deliberation experience system 10 of some embodiments may initiate the forum 50 in response to two or more of these or other suitable start criteria being met.

At block 404, the deliberation experience system 10 may provide an introduction portion of the issue guide to a chat window of the forum 50. As noted above, the introduction portion may include instructions or guidance for the participants to interact via the deliberation platform. Certain embodiments of the introduction portion may additionally or alternatively include background information on the topics of the issue guide. The background portion may be adjusted in length and/or content based on knowledge or familiarity of the participants with the deliberation platform 14, as discussed in more detail with reference to FIG. 9.

At block 406, the deliberation experience system 10 may provide first topic of discussion from the issue guide to the chat window. The first topic may include a question that is directed to the participants, such as to seek their input on the provided topic and encourage engagement with the forum 50. In embodiments, participants may provide messages to the chat window of the forum to deliberate on the topic between themselves. As one example, a first participant may provide a first message addressing the topic, and then a second participant may provide a second message to address the first message and/or the topic. By interfacing with one another through the structure of the deliberation platform 14, the participants may learn valuable insights about each other's opinions and perspectives in a healthy, protected environment that encourages positive and constructive deliberation. The deliberation experience system 10 may allow participation for each topic of discussion for a respective, predetermined time period, in some embodiments. Additionally, certain embodiments may include presenting surveys, questions, and/or ballots to the participants in the forum, such that user input on the various topics of discussion may be collected, analyzed, and/or displayed to facilitate deliberation.

As provided herein, the deliberation experience system 10 also includes various features to guide the deliberation to fit within the overall allotted time for deliberation, while still pursuing effective participation from each individual. At block 410, the deliberation experience system 10 may determine whether a threshold time has elapsed without any participant providing a response or message to the chat window. In some embodiments, this determination is performed via the group participation monitor 106 and/or the timing module 112 of the adaptive moderator system 60. The threshold time may be customized based on the allotted time for discussion, as discussed with reference to the timing module 112 of FIG. 3. In response to determining the threshold time has elapsed without receiving any participant message, at block 412, the deliberation experience system 10 may provide a message to the chat window to encourage group participation in the forum. For example, the moderator script 114 of the adaptive moderator system 60 may prompt participant response by providing a message including additional information associated with the current topic, a follow-up question of smaller or varied scope, a statement that anyone's input is welcome, and/or any other suitable message aimed at the entire group. In some embodiments, the deliberation experience system 10 may also provide an alert to the manager dashboard indicative of the lack of participation from the group, such as in response to an additional threshold time elapsing without response from any participant. As such, the manager may intervene to personally encourage responses, if desired.

Alternatively, in response to determining a participant message to the chat window has been received, the deliberation experience system 10 may analyze individual user contributions to the deliberation, such as via the individual participation monitor 110 of the adaptive moderator system 60. In some embodiments, the deliberation experience system 10 may direct activity levels of the participants to be within a threshold activity level range, ranging between a lower threshold and an upper threshold. For example, at block 414, the deliberation experience system 10 may determine whether a response has been received from an overactive participant. In some embodiments, a participant may be identified as overactive in response to the participant providing more than a threshold number of messages to the current topic of discussion and/or a previous topic of discussion, the participant providing more than an average number of messages per topic, or any other behavior indicative of potentially domineering conversation. In some embodiments, a participant may be identified as overactive in response to the participant having an activity level that is above an upper threshold activity level or outside a threshold activity level range. Indeed, participants may be tagged or identified as overactive via any suitable process or analysis. Additionally, any overactive status of a participant may be reset or removed in response to one or more suitable criteria being met, such as a threshold time elapsing since a previous message from the participant, a threshold number of messages from other participants being provided, the discussion moving to an additional topic of discussion, and so forth.

In response to determining the overactive participant has responded, at block 416, the deliberation experience system 10 may provide a message to the chat window to encourage the overactive participant to pause for other participant input. In some embodiments, the deliberation experience system 10 may also provide an alert to the manager dashboard indicative of the overactive participant, such as in response to receiving further messages from the overactive participant, to provide the manager with an opportunity to intervene personally.

At block 420, the deliberation experience system 10 may also identify any lack of response from an underactive participant. For example, the deliberation experience system may determine whether a specific participant has not provided a message within a threshold amount of time, whether a threshold number of messages from other participants have been received without the specific participant providing a message, whether the specific participant has not yet provided input on the current topic of discussion, or any other suitable behavior indicative of participation being outside a threshold. In some embodiments, a participant may be identified as underactive in response to the participant having an activity level that is below a lower threshold activity level or outside a threshold activity level range. That is, participants may be tagged or identified as underactive via any suitable process or analysis. In response to determining that the underactive participant has not responded, at block 422, the deliberation experience system 10 may provide a message to the chat window to encourage the underactive participant to provide input to the current deliberation. In some embodiments, the deliberation experience system 10 may also provide an alert to the manager dashboard indicative of the underactive participant, such as in response to continued silence of lack of engagement from the underactive participant, to provide the manager with an opportunity to intervene personally. In some embodiments, any underactive status of a participant may be reset or removed in response to a threshold number of messages being provided, input being provided on the current topic of discussion, or another suitable threshold or measure of engagement being met by the participant.

In response to addressing any overactive or underactive users, the deliberation experience system 10 may, at block 424, determine whether a subsequent topic of the issue guide is remaining for discussion. Thus, in response to determining the subsequent topic remains, at block 426, the deliberation experience system 10 may provide the subsequent topic from the issue guide to the chat window. In some embodiments, each subsequent topic of the issue guide may be associated with a respective threshold time for discussion, in which the deliberation experience system 10 will pace deliberation. Thus, the deliberation experience system may return to block 410 to evaluate participant messages during the discussion time provided for deliberating on each provided topic. The deliberation experience system 10 of certain embodiments may therefore provide topics for discussion iteratively or sequentially, pacing conversation to fit in the overall allotted time.

Alternatively, in response to determining that no subsequent topic remains, at block 430, the deliberation experience system 10 may provide a conclusion portion of the issue guide to chat window to conclude the forum. In some embodiments, the conclusion portion may be associated with a survey or questionnaire to receive participant feedback on the deliberation process, which may be used by the deliberation experience system 10 for further refinement.

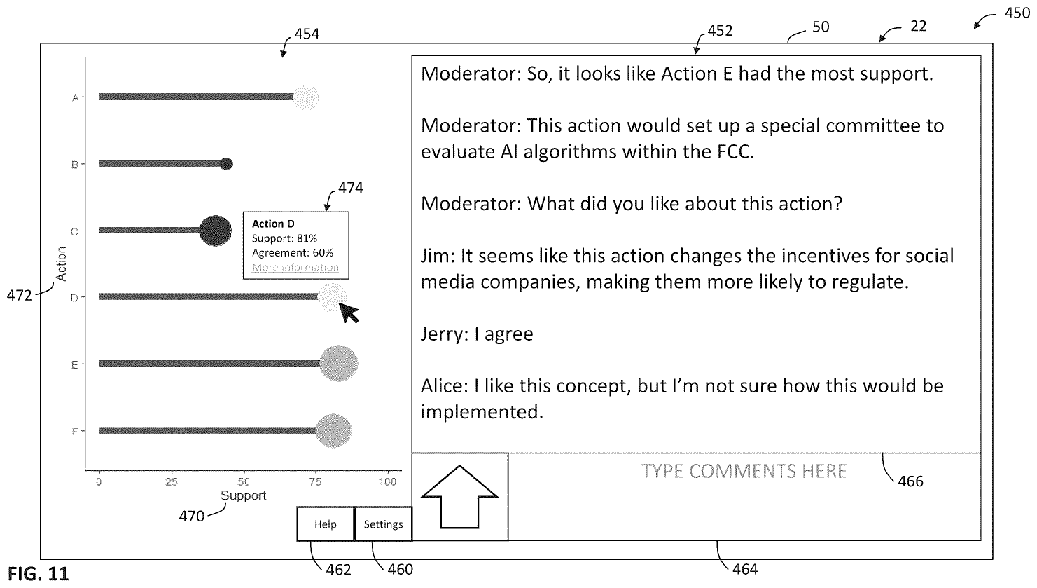

FIG. 11 illustrates an example representation of a forum screen 450, which may be provided to each participant user device 22 of participants assigned to a particular forum. The forum screen 450 may include multiple modules that facilitate participant engagement with each other and the deliberation experience system 10. For example, the illustrated embodiment of the forum screen includes a chat window 452 and a graphical modeling system 454 or graphical modeling window. In an embodiment, the participants may adjust the modules on their respective forum screens 450 to customize the positioning, sizing, coloring, or other features of the modules. Certain functionality to adjust or customize the forum screen 450 may be accessed by selecting a settings button 460. Additionally, certain embodiments of the forum screen 450 may include a help button 462, which may be selected to transmit an alert or message to the manager. As such, participants may request specific assistance from the manager, such as in response to identifying any individual issues.

In more detail, the chat window 452 enables participants to interact with each other and with the CAM 30. For example, each participant may provide text-based messages or comments to an input section 464 of the chat window 452. Thus, the messages from the participants and the CAM 30 may be presented to each member of the forum via a display section 466 of the chat window 452.

The graphical modeling system 454 may display data or representations associated with a current deliberation, in embodiments. For example, the graphical modeling system 454 of certain embodiments may present one or more interactive graphical visualizations to facilitate deliberation activities. The illustrated example of the graphical modeling system 454 includes a multi-dimensional line graph, showing a percent of support 470 or approval for various actions 472 that have been proposed to the participants in the forum. In an embodiment, each participant may provide an indication of approval or an indication of disapproval for each action, and the graphical modeling system 454 presents anonymous, group-level summary data based on the indications from each participant. By hovering or otherwise selecting an interactable feature of the graphical modeling system 454, a participant may cause display of an information box 474, which includes additional details or links regarding an associated action. In some embodiments, the graphical modeling system may include or be substituted with a polling system, such as during periods in which the deliberation experience system 10 seeks feedback from participants on current topics, actions, or questions. The polling system may therefore facilitate collection of participant input regarding opinions on discussion topics, demographic information, and/or feedback on the deliberation experience.

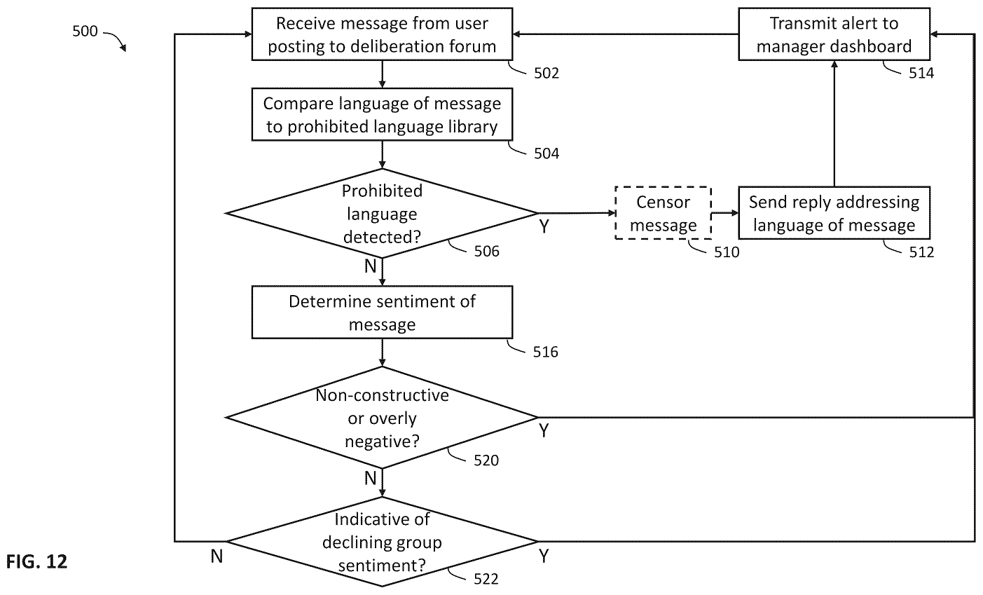

In embodiments, the abuse detection system 64 and/or the question answering system 62 may operate continuously during deliberations to augment the deliberation process for both the manager and all participants. FIG. 12 illustrates an example embodiment of a flow diagram for a process 500 by which the CAM 30 may detect and address any abuse or prohibited language in forums. In embodiments, the abuse detection system 64 of the CAM 30, as introduced in FIG. 4, may perform all or a portion of the following operations. The example process 500 is illustrated as a collection of blocks in a logical flow graph, which represents a sequence of operations. The order in which the operations are described is not intended to be construed as a limitation, and any number of the described blocks may be combined in any order and/or in parallel to implement the process 500.

At block 502, the deliberation experience system 10 may receive a message from a participant posting to the deliberation forum. In embodiments, messages from the participants may be received and analyzed in real time by the deliberation experience system 10. At block 504, the deliberation experience system 10 may compare language or content of the message to the prohibited language library 132. For example, the deliberation experience system 10 of some embodiments may parse the message into individual words, phrases, or portions, which are then compared to entries within the prohibited language library 132. At block 506, the deliberation experience system 10 may determine whether any prohibited language has been detected. For example, the deliberation experience system 10 may determine that prohibited language is present in response to at least a portion of the message overlapping or matching with at least a portion of an entry of the prohibited language library 132.

In response to detecting prohibited language, the deliberation experience system 10 may perform any suitable actions to mitigate participant exposure to the prohibited language. For example, at block 510, the deliberation experience system 10 may censor the associated message. In some embodiments, a censoring sensitivity of the deliberation experience system 10 may be selectively adjusted by the manager, such as during configuration or initialization of a deliberation session. Additionally, some embodiments may enable the manager to select whether censoring is activated or deactivated in the forum. If censoring is deactivated, block 510 may be omitted in some embodiments. If censoring is activated, the deliberation experience system 10 may replace the message or portions thereof with any suitable shapes, symbols, or spaces to obscure the prohibited language. In some embodiments, the censoring of the deliberation experience system 10 may include preventing submission of the message to the display section 466 of the chat window 452. In embodiments, the deliberation experience system 10 may evaluate contents of messages from participants during their construction, thus enabling rapid, real-time censoring of any prohibited language or abusive messages to improve participant experience during deliberation.

At block 512, the deliberation experience system 10 may send a reply addressing the prohibited language of the message from the participant. As a non-limiting example, the CAM 30 of the deliberation experience system 10 may post a message to the display section 466 of the chat window 452 to instruct the participant to refrain from using such language, or rephrase their message without the prohibited language. At block 514, the deliberation experience system 10 may transmit an alert to the manager dashboard. This alert thus allows the manager to provide any further corrective actions or manager responses, such as temporarily muting the participant if more than a threshold number of abusive messages have originated from the participant.

In response to no prohibited language being detected, at block 516, the deliberation experience system 10 may determine a sentiment of the message. For example, using natural language processing, the deliberation experience system 10 may extract an intent, tone, quality, or other metric indicative of the message. At block 520, the deliberation experience system 10 may determine whether the sentiment is non-constructive or overly negative. In response to the sentiment being more negative than a threshold, the deliberation experience system may proceed to block 514 to transmit a corresponding alert to the manager dashboard. In embodiments, deliberation experience system 10 may therefore identify certain messages that do not include any specifically prohibited language, but otherwise include sentiments that are not constructive to the current deliberation.

At block 522, the deliberation experience system 10 may determine whether the message is indicative of a declining sentiment within the forum. As an example, the message itself may not be overly negative, but indicate that discussion within the forum is heading in a negative direction. As such, in response to determining the message is indicative of declining group sentiment, the deliberation experience system may proceed to block 514 to transmit a corresponding alert to the manager dashboard. In response to determining the message includes no prohibited language and raises no sentiment-based concerns, the deliberation experience system 10 may return to block 502 to continue receiving and analyzing messages from the participants. The deliberation experience system 10 may therefore provide robust and secure abuse protection measures to protect the participants from any undesirable messages during deliberation.

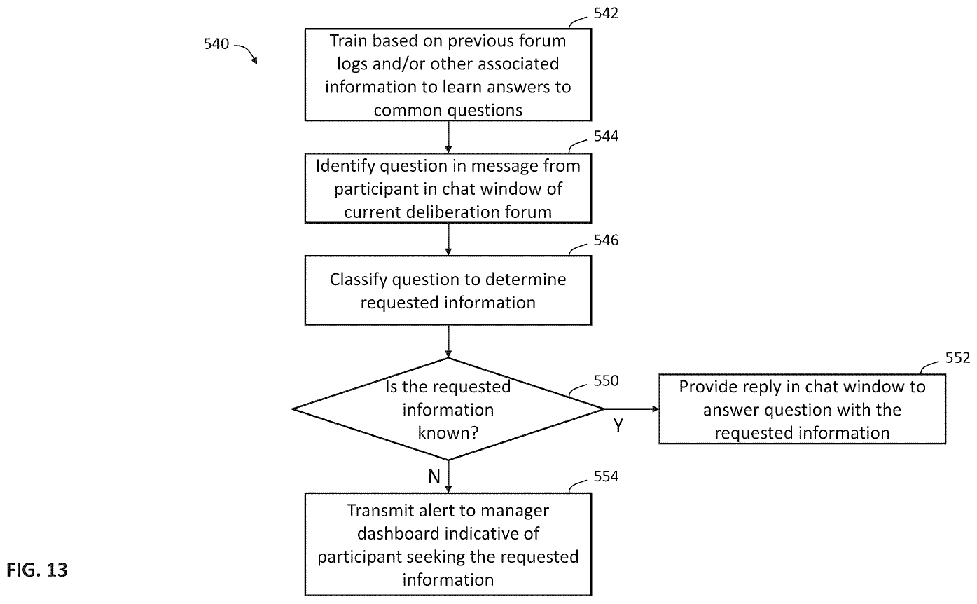

FIG. 13 illustrates an example embodiment of a flow diagram for a process 540 by which the deliberation experience system 10 may respond to or address any participant questions in the forums. In embodiments, the question answering system 62, as introduced in FIG. 5, may perform all or a portion of the following operations. The example process 540 is illustrated as a collection of blocks in a logical flow graph, which represents a sequence of operations. The order in which the operations are described is not intended to be construed as a limitation, and any number of the described blocks may be combined in any order and/or in parallel to implement the process 540.

At block 542, the deliberation experience system 10 may be trained based on previous forum logs and/or other associated information to learn previous or common questions, as well as their associated answers or requested information. For example, the AI transformer 150 of the question answering system 62 may be trained via the previous forum logs 152. The AI transformer 150 of certain embodiments may therefore have access to answers for questions that have been encountered previously. In embodiments, the training may be completed before the initialization of a current deliberation on the deliberation experience system 10. Certain embodiments may also include, after completion of a current deliberation, storing each forum log with the previous forum logs 152 and repeating the training process to continuously improve the ability of the deliberation experience system 10 to answer participant questions.

At block 544, the deliberation experience system 10 may identify a question in a message from a participant in the chat window of the current deliberation forum. For example, the deliberation experience system 10 may include specific programming or have been trained to detect questions within messages provided by the participants. At block 546, the deliberation experience system 10 may classify a detected question to determine the requested information associated with the question. For example, certain embodiments may include a respective category for each type of question previously encountered by the deliberation experience system based on the information requested by the question.

At block 550, the deliberation experience system 10 may determine whether the requested information is known. For example, the deliberation experience system 10 may query databases thereof with the requested information as a search parameter. In response to determining that the requested information is known, at block 552, the deliberation experience system 10 may provide a reply in the chat window to answer the question with the requested information.

In response to determining that the requested information is known or that the question is novel, at block 554, the deliberation experience system 10 may transmit an alert to the manager dashboard indicative of the new question. In some embodiments, the alert may include an indication of a novel question in a particular forum, and the manager may interact with the alert to join the particular forum and answer the question. In some embodiments, the alert may include a reproduction or representation of the novel question and a response text box, such that the manager may provide an answer to the response text box from the manager dashboard for the deliberation experience system 10 to relay to the forum. In response to receiving a manager response to the question, the deliberation experience system 10 of some embodiments may store the response with the question, such that any future instances or variants of the question may be automatically addressed by the deliberation experience system 10.

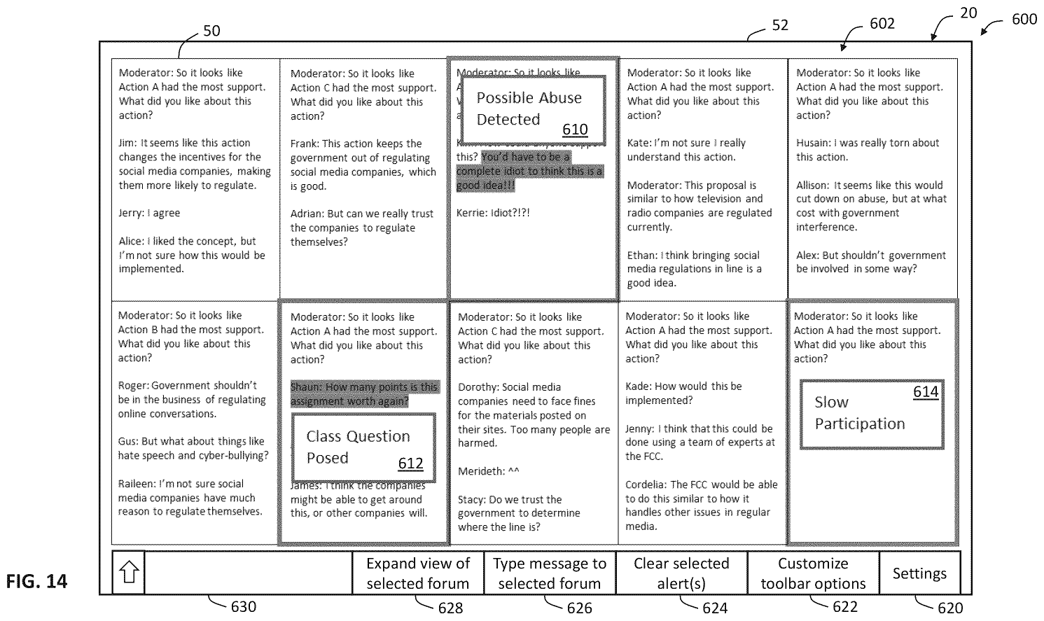

FIG. 14 illustrates a representation of a forum management screen 600 including an example of a panoptic forum view 602, which may be presented on the manager dashboard 52 of the manager user device 20. The illustrated embodiment of the panoptic forum view 602 includes a representation of each forum 50, which may include one or more messages recently displayed in each forum 50. As such, the manager may receive and maintain an overview of a general pace of discussion, which is efficiently managed by the deliberation experience system 10. As discussed above, alerts may be transmitted to the manager dashboard 52 in situations in which manager input may be beneficial. As non-limiting examples, a first alert 610, second alert 612, and third alert 614 are provided as overlays onto the respective forums with which the alerts are associated. In the illustrated embodiment, the first alert 610 indicates potential abusive or non-constructive language, the second alert 612 indicates a novel question, and the third alert 614 indicates slow group participation.

In other words, the deliberation experience system 10 may provide one or more alerts to the manager dashboard 52 in response to identifying an event associated with manager intervention in a particular forum. The manager may therefore delegate a majority of formulaic actions associated with operating the forums 50 to the deliberation experience system 10, while conserving managerial attention for addressing more dynamic events, such as novel questions, abusive messages, declining sentiments, overactive participants, underactive participant, or underactive groups of participants. In some embodiments, the deliberation experience system 10 may receive a corrective action or a manager response to a dynamic event from the manager dashboard 52, and perform or relay the manager response to the associated forum 50.

In embodiments, the manager dashboard 52 or forum management screen 600 thereof may also include multiple, customizable features to increase an efficiency with which the manager may interact with the forums 50. The illustrated embodiment includes a settings button 620 that may be selected to adjust any suitable features or settings of the deliberation experience system. Certain embodiments may also include a customize toolbar option 622, which may be selected to adjust, select, or deselect buttons and features that are displayed on a toolbar of the forum management screen 600.

The manager dashboard 52 may also include a clear selected alert(s) button 624 that is usable to clear alerts provided by the deliberation experience system 10, such as in response. Certain embodiments may also include a type message to selected forum button 626, an expand view of selected forum button 628, and/or and a text input box 630. Using these or any other suitable combination of selectable features, the manager may maintain a panoptic perspective of the forums 50, enhanced with the ability to click and join any forum and exit back to the panoptic forum view 602. It should be understood that the particular contents and positioning thereof on the forum management screen 600 are provided as examples, and features may be combined, omitted, or augmented with additional features to enable the deliberation experience system 10 to enable the manager to oversee and manage a large number of forums simultaneously, with support by the CAM 30.

Having thus described several aspects of the various embodiments, it is to be appreciated various alterations, modifications, and improvements will readily occur to those skilled in the art. Such alterations, modifications, and improvements are intended to be part of this disclosure, and are intended to be within the spirit and scope of the present disclosure. Accordingly, the foregoing description and drawings are by way of example only.

What is claimed is:

1. A deliberation experience system, comprising:
a memory storing processor-executable instructions of a deliberation platform; and
one or more processors communicatively coupled to the memory and configured to execute the processor-executable instructions from the memory, the one or more processors configured, when executing the instructions, to:
generate and provide a manager dashboard of the deliberation platform to a manager user device, wherein the manager dashboard is configured to present, on the manager user device, a list of participant user devices and a list of issue guides with topics for discussion in a plurality of forums of the deliberation platform;
receive, via the manager dashboard, a first selection from the manager user device requesting assignment of a respective set of the participant user devices to each respective forum of the plurality of forums, and in response, communicatively couple the respective set of the participant user devices to each respective forum;
receive, via the manager dashboard, a second selection from the manager user device selecting an issue guide from the list of issue guides, and in response, instruct a computer-automated moderator of the deliberation platform to moderate the discussions in the plurality of forums, wherein moderating comprises: transmitting each of the topics of the selected issue guide to the respective set of the participant user devices of each respective forum, processing received responses from the respective set of the participant user devices associated with each respective forum, and generating a respective representation of each respective forum based on the processing of the received responses; and
present, via the manager dashboard, the respective representation of each respective forum on the manager dashboard.

2. The deliberation experience system of claim 1, wherein the one or more processors are configured, when executing the instructions, to:
receive, via the manager dashboard, a third selection from the manager user device indicative of an allotted time period for deliberation;
automatically determine a respective portion of the allotted time period for each of the topics of the selected issue guide; and
associate each topic of the selected issue guide with the respective portion of the allotted time period.

3. The deliberation experience system of claim 1, wherein the one or more processors are configured, when executing the instructions, to present an interactive graphical visualization in each respective forum comprising data collected from polling the respective set of the participant user devices of each respective forum.

4. The deliberation experience system of claim 1, wherein each forum comprises a user interface presented on a display of each participant user device of the respective set of the participant user devices, and wherein the user interface comprises a graphical modeling window that presents visualizations and a chat window to collect text-based responses from each participant user device of the respective set.

5. The deliberation experience system of claim 1, wherein the one or more processors are configured, when executing the instructions, to:
identify a respective participant user device of a participant having an activity level above an upper threshold within a particular forum of the plurality of forums; and
provide, via the particular forum, a message to the respective participant user device to request that the participant pause for input from other participants.

6. The deliberation experience system of claim 1, wherein the one or more processors are configured, when executing the instructions, to:
identify one or more participant user devices of participants having an activity level below a lower threshold within a particular forum of the plurality of forums; and
provide, via the particular forum, a message to the one or more participant user devices to request input therefrom.

7. The deliberation experience system of claim 1, wherein the one or more processors are configured, when executing the instructions, to:
identify one or more received responses from the respective set of the participant user devices as including a question;
determine whether an answer to the question is available based on querying a database of previous forum logs;
in response to determining an answer to the question is available, provide a reply to the respective set of the participant user devices including the answer; and
in response to determining the answer to the question is not available, provide an alert to the manager dashboard indicative of the question.

8. The deliberation experience system of claim 1, wherein the one or more processors are configured, when executing the instructions, to:
analyze each received response from the respective set of the participant user devices to determine whether prohibited language is included therein;
identify one or more received responses from a respective participant user device as including prohibited language; and
provide a reply to the respective participant user device to address the prohibited language.

9. The deliberation experience system of claim 1, wherein the one or more processors are configured, when executing the instructions, to:
analyze each received response from the respective set of the participant user devices to determine a sentiment of discussion in a particular forum;
identify one or more responses from the respective set of the participant user devices as indicative of a decline in the sentiment in the particular forum;
provide an alert to the manager dashboard indicative of the decline in the sentiment; and
provide a manager response to the particular forum to address the decline in the sentiment.

10. The deliberation experience system of claim 1, wherein the one or more processors are configured, when executing the instructions, to:
flag an event for manager intervention in a particular forum, wherein the event comprises a novel question, an abusive response, a declining sentiment of discussion, an overactive participant, an underactive participant, or an underactive group of participants;
provide an alert to the manager dashboard in response to identifying the event; and
receive a corrective action or a manager response to the event from the manager dashboard.

11. The deliberation experience system of claim 1, wherein the first selection comprises an indication of a random assignment type or one or more manual selections of forum assignments.

12. The deliberation experience system of claim 1, wherein the first selection comprises an indication of a diverse sorting type, and wherein the one or more processors are configured, when executing the instructions, to:
retrieve one or more variables associated with each participant of the list of participant user devices from a participant database; and
select the respective set of the participant user devices for each forum to cause a first distribution of the one or more variables associated with the respective set of the participant user devices to match a second distribution of the one or more variables associated with the list of participant user devices.

13. A process for managing a deliberation experience system for participant engagement, the process comprising:
generating a deliberation platform having a plurality of forums communicatively coupled to a plurality of participant user devices, each forum of the plurality of forums including a chat window that displays messages from a subset of participant user devices;
receiving an indication of a selected issue guide from a manager user device;
providing an introduction portion and a first topic of the selected issue guide to the chat window of each forum;
receiving one or more messages in the chat window of each forum from the subset of participant user devices to enable automated moderation of discussion in each forum;
in response to identifying a question in at least one message of the one or more messages, providing a first response to the question in the chat window of an associated forum of the plurality of forums;
in response to identifying a prohibited phrase in at least one message of the one or more messages, providing a second response to the prohibited phrase in the chat window of an associated forum of the plurality of forums;
in response to a subsequent topic of the selected issue guide remaining, providing the subsequent topic to the chat window of each forum; and
in response to no subsequent topic of the selected issue guide remaining, providing a conclusion portion of the selected issue guide to the chat window of each forum.

14. The process of claim 13, further comprising, in response to identifying a second question in at least one message of the one or more messages and determining that an answer to the second question is not available, providing an alert to a manager dashboard indicative of the second question.

15. The process of claim 13, further comprising:
identifying at least one message of the one or more messages as indicative of a declining sentiment in a particular forum; and
providing an alert to a manager dashboard indicative of the declining sentiment in the particular forum.

16. The process of claim 13, further comprising:
identifying a participant user device of the subset of participants as being associated with a participant having an activity level outside a threshold activity level range; and
providing a message to the participant user device to direct the activity level to be within the threshold activity level range.

17. The process of claim 13, further comprising distributing the plurality of participant user devices into the plurality of forums to form the subset of participant user devices for each forum via a diverse sorting algorithm or a random sorting algorithm.

18. The process of claim 13, wherein the deliberation platform comprises a manager dashboard presented on a manager user device, and wherein the manager dashboard comprises a user interface having a panoptic forum view of the plurality of forums.

19. The process of claim 13, further comprising:
identifying at least one forum as having participant user devices associated with participants with at least a threshold familiarity with the deliberation experience system; and
customizing a moderator script for the at least one forum to include fewer instructions for guiding interactions on the deliberation platform.

20. A non-transitory machine-readable storage medium of a deliberation experience system, the non-transitory machine-readable storage medium including instructions executable by one or more processors, comprising instructions to:
generate a deliberation platform including a plurality of forums and a manager dashboard to facilitate monitoring deliberation in each forum of the plurality of forums, the manager dashboard presented on a manager user device;
receive a first input from the manager user device indicative of assigning a respective set of participant user devices to each forum and communicatively couple the respective set of participant user devices to each forum;
receive a second input from the manager user device indicative of a selected issue guide of a plurality of issue guides, the selected issue guide including a plurality of discussion topics;
receive a third input from the manager user device indicative of an allotted time period for deliberation, each discussion topic of the selected issue guide being associated with a respective portion of the allotted time period;
instruct a computer-automated moderator to initiate a guided discussion on each forum by progressing through each discussion topic of the selected issue guide in each forum; and
collect and present data associated with participant opinions from the respective set of participant user devices on one or more proposed actions of the selected issue guide on each forum.
